(19) United States
(12) Patent Application Publication
(10) Pub. No.: US 2022/0044562 A1
(43) Pub. Date: Feb. 10, 2022

(54) SYSTEM AND A METHOD FOR DETECTING AN APPROACHING EMERGENCY RESPONSE VEHICLE

(71) Applicant: Donald Schaak, Phoenix, AZ (US)

(72) Inventor: Donald Schaak, Phoenix, AZ (US)

(21) Appl. No.: 16/987,652

(22) Filed: Aug. 7, 2020

(51) Int. Cl. G08G 1/0965; B60W 50/16

(52) U.S. Cl. CPC G08G 1/0965; B60W 2420/54; B60W 50/16

(57) ABSTRACT

A system and a method for a detecting emergency response vehicle approaching a vehicle is disclosed herein. The system comprises one or more processors and one memory coupled to the processor. The memory includes a database of siren audio signatures along with instructions for the processor to perform operations comprising: capturing sound waves within a first pre-defined periphery around a vehicle for generating a first raw signal; processing, via a signal processing unit, the first raw signal to detect if the first raw signal includes a sound signature matching with one siren audio signature from the database, and correspondingly generate a second signal; generating a third signal based on the second signal; and generating indications via a plurality of indicator units in the vehicle on receiving the third signal for alerting a driver of the vehicle of an approaching emergency response vehicle.

### TECHNICAL FIELD

The present disclosure relates generally to detection of an approaching emergency response vehicle.

### BACKGROUND

Emergency response vehicles are vehicles that are designated for usage during emergency situations. Examples of emergency response vehicles include ambulances, fire trucks, police cars, and the like. A commonality in all of the aforementioned emergency response vehicles is that all of them employ the use of a siren. The function of the siren is to alert surrounding vehicles to either make way for the approaching emergency response vehicle or completely stop the vehicle in compliance with the instructions of the authority present in the approaching emergency response vehicle. Sometimes the driver of the vehicle may not be in an optimal state of mind and may not pay attention to the sound of the siren. For example, the driver may be listening to loud music or distracted by a young child. In such a situation, where the driver of the vehicle fails to detect the approaching emergency response vehicle, an accident or a similar catastrophe may occur.

### SUMMARY

The present disclosure envisages a system for detecting emergency response vehicle approaching a vehicle. The system comprises one or more processors and one or more computer-readable non-transitory storage media coupled to one or more of the processors. The one or more computer-readable non-transitory storage media comprise instructions operable when executed by one or more of the processors to cause performance of operations comprising: capturing sound waves within a first pre-defined periphery around a vehicle, via a sound capturing unit, wherein the sound capturing unit is disposed at a location either on an exterior of the vehicle or an interior of the vehicle for generating a first raw signal; processing, via a signal processing unit, the first raw signal to detect if the first raw signal includes a siren audio signature matching with one siren audio signature from a database of siren audio signatures pre-fed into the storage media, and correspondingly generate a second signal; receiving the second signal and generating a third signal based on whether the second signal includes the siren audio signature matching with one siren audio signature from the database of siren audio signatures; and transmitting the third signal to a plurality of indicator units configured within the interior of vehicle, wherein the plurality of indicator units is configured to generate indications on receiving the third signal for alerting a driver of the vehicle of an approaching emergency response vehicle.

### BRIEF DESCRIPTION OF THE DRAWINGS

FIG. 1 shows an exemplary block diagram of a system for detecting an approaching emergency response vehicle, according to a first embodiment of the present disclosure.

FIG. 2 shows an exemplary block diagram of a method for detecting an approaching emergency response vehicle, according to a first embodiment of the present disclosure.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

Emergency response vehicles generally employ the usage of sirens to alert the surrounding traffic of their approach so that the surrounding vehicles may either come to a stop or make way for the approaching emergency response vehicle. As mentioned previously, if one or more drivers of vehicles in the surrounding vehicles are not attentive to the siren sound of the approaching emergency response vehicle, the consequences of the same may be catastrophic at times. For example, if an ambulance is making its way through heavy traffic, and a driver of one of the vehicles fails to notice the ambulance and fails to make way for the ambulance, the advance of the ambulance may be delayed, which is not desired at all since lives may be at stake in such a scenario. Another example is where a police vehicle approaches a vehicle, and if the driver fails to detect the approach of the police vehicle and keeps on driving, the driver may be booked for committing a criminal act and may be charged a fine as well as prison time.

Therefore, the present disclosure envisages a system and a method that detects and alerts the driver of a vehicle a number of times of an approaching emergency response vehicle. In accordance with an embodiment of the present disclosure, the alerts may be in the form of audio alerts, visual alerts, and physical alerts. The term physical alert herein refers to an actuation of vibration motors that may be disposed at one or more locations near the driver of the vehicle for providing a nudge or a haptic feedback to the driver, thereby alerting the driver of an approaching emergency response vehicle.

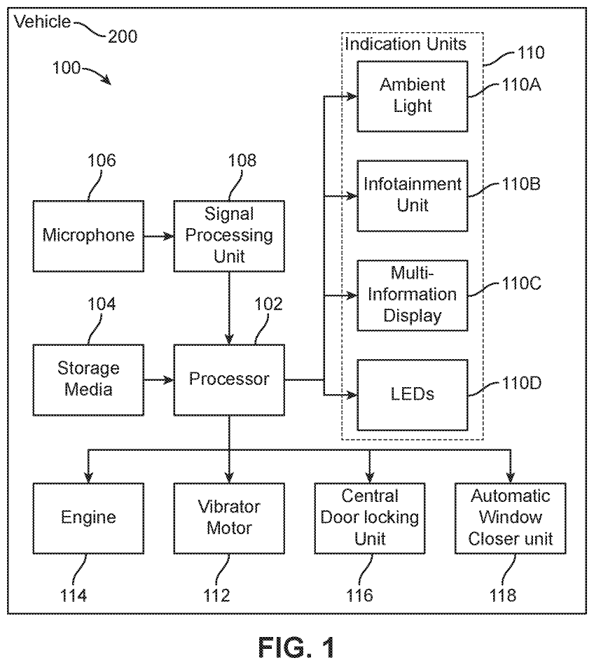

Referring to FIG. 1, an exemplary block diagram of a system for detecting an approaching emergency response vehicle 100 (hereinafter referred to as system 100), according to a first embodiment of the present disclosure, is illustrated. The system 100, in accordance with an exemplary embodiment of the present disclosure, is deployed on a vehicle 200. The system 100 includes one or more on-vehicle processors 102. The processor(s) 102 may be implemented as one or more microprocessors, microcomputers, microcontrollers, digital signal processors, central processing units, state machines, logic circuitries, and/or any devices that manipulate signals based on operational instructions. Among other capabilities, the processor(s) 102 may be configured to fetch and execute computer-readable instructions or processor-accessible instructions stored in a computer-readable storage media 104.

In accordance with a non-limiting embodiment, the storage media 104 is an example of computer-readable storage media for storing instructions which are executed by the processor(s) 102 to perform the various functions that are explained in the subsequent sections of the present disclosure. For example, the storage media 104 may generally include both volatile memory and non-volatile memory (e.g., RAM, ROM, or the like). The storage media 104 is capable of storing computer-readable, processor-executable program instructions as computer program code that may be executed by the processor(s) 102 as a particular machine configured for carrying out the operations and functions described in the implementations herein.

The system 100 further comprises a microphone 106 (also referred to as a sound capturing unit). The microphone 106 may be disposed either on an external surface of the vehicle 200 or at a location in the interior of the vehicle 200. The microphone 106 is configured to capture all sounds in the vicinity of the vehicle 200 within a pre-defined periphery. In one exemplary embodiment, the microphone 106 is configured to capture sounds within a periphery of 200m around the vehicle 200. An advantageous aspect of capturing all sounds in the pre-defined periphery is that the driver of the vehicle 200 is alerted of the approaching vehicle well in advance to allow the driver to make an appropriate decision regarding either making way for the approaching emergency response vehicle or stopping the vehicle 200 in compliance with instructions of the authority present within the emergency response vehicle.

In accordance with an embodiment of the present disclosure, the microphone 106 is configured to capture sounds within the pre-defined periphery to generate first raw signals. The first raw signals include all the different sounds that are present within the pre-defined periphery of the vehicle 200. These first raw signals are then processed further to detect the presence of a sound within the captured sounds that corresponds to one siren audio signature out of a plurality of siren audio signatures that is pre-fed into the storage media 104. More specifically, the storage media 104 may include siren audio signatures for a variety of siren sounds, including but not limited to, fire truck, law enforcement vehicles, ambulances, and the like.

The system 100 further comprises a signal processing unit 108. The signal processing unit 108 is communicatively coupled to the microphone 106 and configured to receive the first raw signals from the microphone 106. In accordance with an exemplary embodiment of the present disclosure, the signal processing unit 108 can be any signal processor that can receive the first raw signals from the microphone 106, convert the analog first raw signals to a digital format, filter the digitized first raw signal, and detect whether any sound within the digitized first raw signal matches with at least one siren audio signature that is pre-fed into the storage media 104. In one embodiment, to determine to whether any sound in the digitized first raw signal corresponds to any of the siren audio signatures, a frequency and a sound cycle timing of the sound in the digitized first raw signal is mapped against the frequency and the sound cycle timing of the different siren audio signatures that are pre-fed into the storage media 104. If an appropriate match is detected by the signal processing unit 108, then the signal processing unit 108 is configured to generate a second signal.

In one example, the storage media 104 includes the database of the different siren audio signatures. More specifically, if a particular emergency response vehicle has more than one typically used siren audio signature, each of the siren audio signature is marked as belonging to that particular emergency response vehicle. For example, if a law enforcement vehicle has more than one typically used siren audio signature at a particular location, each siren audio signature is marked as indicating an approaching law enforcement vehicle. Therefore, the system 100, in accordance with an embodiment of the present disclosure, is configured to detect all variants of siren audio signatures that may belong to a single emergency response vehicle category. An advantageous aspect of this feature is that no matter what kind of siren is being used by the emergency response vehicle, the signal processing unit 108 may accurately determine the category of the approaching emergency response vehicle.

It is to be noted that some emergency response vehicles employ the use of sirens, which emit an audio in which high frequency and low frequency sounds are used in tandem. More specifically, a single siren may have different operating modes, including but not limited to, wail, high/low, and yelp operating modes. In the aforementioned operating modes, the frequency and audio cycle timing of the siren audio signature are varied as per the requirement of certain emergency situations. In one embodiment, information regarding these different operating modes may be included as well in the database of the different siren audio signatures that is pre-fed into the storage media 104. An advantageous aspect of such a feature is that the signal processing unit 108 may detect under what mode an approaching siren is operating based on the siren audio signature, thereby prompting the processor 102 to generate an appropriate indication for the driver.

In another example, the storage media 104 may be provided with all the different usually occurring sounds that occur on a driver's typical commute route. Any other sound occurring outside of the aforementioned database of sounds and belonging to a pre-defined frequency range may be considered as the sound of a siren of an approaching emergency response vehicle.

In one embodiment of the present disclosure, the storage media 104 also includes a Doppler effect factor stored therein. Doppler effect is the change in frequency of a wave in relation to an observer who is moving relative to the wave source. In accordance with an embodiment of the present invention, the Doppler effect factor is used by the processor 102 to overcome the variation in the frequency readings that are generated due to the Doppler effect.

In accordance with an embodiment of the present disclosure, signal processing unit 108 may trigger the generation of the second signal when there is a partial match (e.g., 90% to 100% match) in the frequency of a sound present in the raw signal with that present in the database stored in the storage media 104.

In accordance with an exemplary embodiment of the present disclosure, the second signal is then transmitted to the processor 102. Once the processor 102 determines the presence of the emergency response vehicle in the pre-defined periphery of the vehicle 200, the processor 102 then generates a third signal which is transmitted to a plurality of indicator units 110 present in the interior of the vehicle 200. In one embodiment, the third signals are alert notifications. In one embodiment, the plurality of indicator units 110 may include an ambient light 110A, an infotainment unit 110B, a multi-information display 110C of the vehicle 200, LEDs 110D, and the like. In one embodiment, the infotainment unit 110B may be configured to provide the alert notification regarding the approaching emergency vehicle in the form of an audio message. In another embodiment, the infotainment unit 110B may be configured to provide the alert notification regarding the approaching emergency vehicle in the form of a video message appearing on the display of the infotainment unit 110B. A similar video message may also be provided on the multi-information display 110C, in accordance with an embodiment of the present disclosure.

As mentioned previously, some sirens on the emergency response vehicles are configured for operation in different modes, e.g., wail, high-low, yelp, etc. The different modes of siren operation are decided specific to different situations. In one embodiment, the second signal generated via the signal processing unit 108 may include information regarding the operational mode of the approaching siren. In accordance with an embodiment of the present disclosure, the processor 102 may generate an appropriate alert notification, which is based on the operational mode of the siren of the approaching emergency response vehicle. For example, one such message may be “Fire truck in nearby vicinity. Yield to vehicle. Exercise caution”, which may be displayed on the screens of the infotainment unit 110B and the multi-information display 110C, accompanied with an audio message conveyed by the speakers associated with the infotainment unit 110B.

Although the present disclosure focuses on detection of sirens associated with approaching emergency vehicles, other types of sirens could also be detected. For example, civil defense sirens are often used to warn a population of an impending emergency event such as a tornado. As with other sirens, civil defense sirens have distinct siren audio signatures allowing detection using the techniques disclosed herein. In various embodiments, once a particular civil defense siren is detected, appropriate action can be taken (e.g., displaying an informative message regarding the emergency to the driver). In other embodiments, the detection of the civil defense siren can be filtered so that no action is taken.

At times, these audio and visual alerts may not be sufficient due to the driver of the vehicle not being in the best state of mind. For example, at times the driver may have suffered a loss in the form of a death of a loved one or any similar situation. In such a situation, it is quite possible that driver is not in the best state of mind, and the audio and visual alerts are not sufficient to alert the driver of the vehicle 200 of the approaching emergency response vehicle. In such a situation, a physical alert in the form of a nudge or a haptic feedback to the driver of the vehicle 200 is helpful. To this end, the system 100 may further include a vibration motor 112 disposed within a driver seat, in one embodiment. In another embodiment, the vibration motor 112 may be located within a steering wheel of the vehicle 200. In yet another embodiment, vibration motors 112 may be provided within the driver seat as well as the steering wheel of the vehicle 200.

In accordance with an exemplary embodiment of the present disclosure, the processor 102 is communicatively coupled to the vibration motor 112. The processor 102 communicates with the vibration motor 112 via the third signal. As soon as the vibration motor 112 receives the third signal, a physical notification in the form of a nudge or a haptic feedback is provided to the driver of the vehicle 200. The physical notification along with the audio and visual notifications ensure that the driver of the vehicle 200 is made aware of the approaching emergency response vehicle.

In some other implementations, the system 100 can also be configured to prevent high speed car chases involving law enforcers and criminal suspects. High speed car chases are extremely dangerous not only to the people involved in the chase but the surrounding vehicles as well. In order to mitigate this pressing issue prevalent in the society today, the system disclosed herein envisages a feature in which an engine 114 of the vehicle 200 is gradually detuned once the audio, visual, and/or physical alerts are generated. More specifically, the processor 102 is communicatively coupled to the engine 114. Once the third signals are generated by the processor 102 and alerts are successfully generated, the processor 102 gradually detunes the operation of the engine 114 to bring the vehicle 200 to a complete halt. Once the signal processing unit 108 detects that the siren audio signature of the approaching emergency response vehicle belongs of a law enforcement vehicle, the processor 102 is prompted to initiate the operation of gradually detuning the engine 114, in accordance with one exemplary embodiment of the present disclosure.

In accordance with an embodiment of the present disclosure, the processor 102 is communicatively coupled to a central door locking unit 116 and an automatic window closer unit 118 of the vehicle 200. As the vehicle 200 is brought to a complete halt, the processor 102 sends a signal to the central door locking unit 116 to unlock the doors of the vehicle 200 subsequent to coming to the complete halt. In one embodiment, the processor 102 may be configured to provide repeated “unlock” signals to the central door locking unit 116 to keep the doors unlocked. In another embodiment, the processor 102 may send a “disable locking” signal to the central door locking unit 116. Furthermore, after the doors of the vehicle 200 are unlocked, the processor 102 sends a signal to the automatic window closer unit 118 to partially open the driver side window. In another embodiment, the processor 102 may be configured to send an “open” signal to the automatic window closer unit 118 to facilitate opening of all the windows of the vehicle, thereby making the process more secure for the law enforcing authorities. These actions performed by the processor 102 allow a law enforcing authority to easily apprehend a criminal suspect present in the vehicle 200 without endangering the lives of the people in the surrounding vehicles by eliminating the possibility of a high speed pursuit.

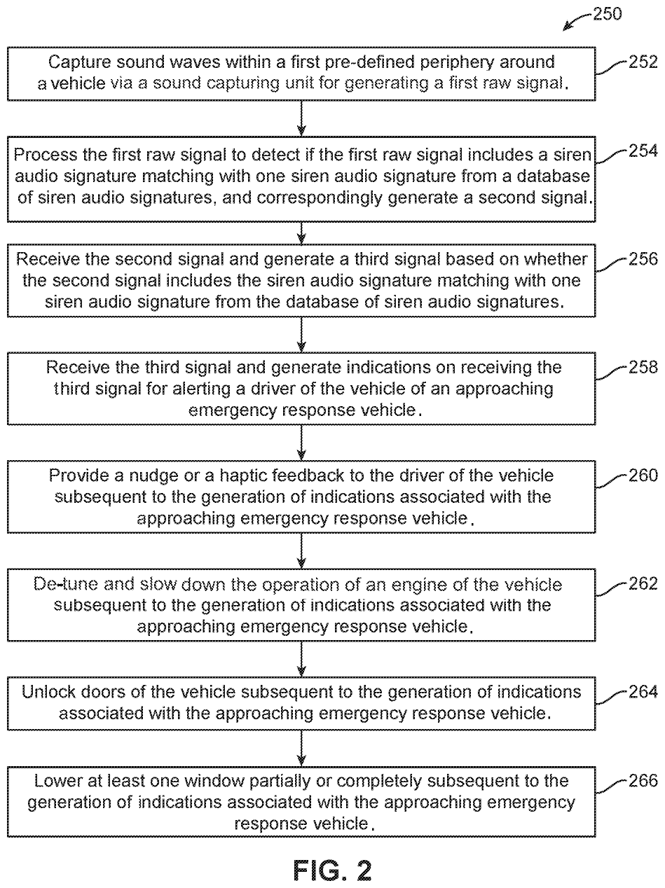

Referring to FIG. 2, an exemplary block diagram of a method for detecting an approaching emergency response vehicle 250 (hereinafter referred to as method 250), according to a first embodiment of the present disclosure, is illustrated. The order in which the method 250 is described is not intended to be construed as a limitation, and any number of the described method blocks can be combined in any order to implement the method or any alternative methods. Additionally, individual blocks may be deleted from the method without departing from the spirit and scope of the subject matter described herein. Furthermore, the method can be implemented in any suitable hardware, software, firmware, or combination thereof.

At block 252, the method 250 includes the step of capturing sound waves within a first pre-defined periphery around a vehicle, via a sound capturing unit for generating a first raw signal. In an embodiment, the sound is captured by a microphone 106. The captured sound may include all the noises present in the area within a pre-defined periphery of the vehicle 200. This sound may include the sound of siren deployed on an emergency response vehicle present in the pre-defined periphery.

At block 254, the method 250 includes the step of processing the first raw signal to detect if the first raw signal includes a siren audio signature matching with one siren audio signature from a database of siren audio signatures, and correspondingly generate a second signal. In an embodiment, the processing of the first raw signal is facilitated by the signal processing unit 108. The second signal is generated only when it is determined that an emergency response vehicle is approaching. The step of processing may further include converting the first raw signal in a digital format, filtering the digitized first raw signal, and detecting if any sound present in a digitized raw signal matches with one siren audio signature from the database of siren audio signatures that is pre-fed into the storage media 104 of the system 100.

At block 256, the method 250 includes the step of receiving the second signal and generating a third signal based on whether the second signal indicates the presence of the siren audio signature matching with one siren audio signature from the database of siren audio signatures. In an embodiment, the third signal is generated by the processor 102. The generation of the third signal is an indication that an emergency response vehicle is approaching. In one embodiment, based on detected siren audio signature, the category of the approaching emergency response vehicle may also be detected, e.g., fire truck, ambulance, law enforcement vehicle, and the like.

At block 258, the method 250 includes the step of receiving the third signal and generating indications on receiving the third signal for alerting a driver of the vehicle of an approaching emergency response vehicle. In an embodiment, the generation of indications is performed by the plurality of indicator units 110. In an embodiment, the plurality of indicator units 110 may include an ambient light 110A, an infotainment unit 110B, a multi-information display 110C of the vehicle 200, LEDs 110D, and the like. The indicator units 110 may facilitate the generation of audio and video notifications to alert the driver of the vehicle 200 of an approaching emergency response vehicle. As mentioned previously, the indications may be custom designed to be displayed subsequent to detection of each specific siren audio signature present in the database of the siren audio signatures pre-fed to the storage media 104.

At block 260, the method 250 includes the step of providing a nudge or a haptic feedback to the driver of the vehicle subsequent to the generation of indications associated with the approaching emergency response vehicle. In accordance with an embodiment of the present disclosure, the nudge or the haptic feedback is provided by one or more vibration motors 112. The vibration motors 112 may be located within the driver seat or the steering wheel. The physical notification in the form of a nudge or haptic feedback accompanied by the audio and visual notifications ensure that the driver of the vehicle 200 is alerted of the approaching emergency vehicle.

At block 262, the method 250 includes the step of gradually detuning and slowing down the operation of an engine of the vehicle subsequent to the generation of indications associated with the approaching emergency response vehicle. In an embodiment, the detuning of the engine is facilitated by the processor 102. It is to be noted that the step 262 is performed when the processor 102 and the signal processing unit 108 detect that the approaching emergency response vehicle is a vehicle belonging to a law enforcing authority.

At block 264, the method 250 includes the step of unlocking doors of the vehicle subsequent to the generation of indications associated with the approaching emergency response vehicle. In an embodiment, the unlocking of the doors of the vehicle is facilitated by the processor 102, which is communicatively coupled to the central door locking unit 116. In one embodiment, the processor 102 may be configured to provide repeated “unlock” signals to the central door locking unit 116 to keep the doors unlocked. In another embodiment, the processor 102 may send a “disable locking” signal to the central door locking unit 116. It is to be noted that the step 264 is performed when the processor 102 and the signal processing unit 108 detect that the approaching emergency response vehicle is a vehicle belonging to a law enforcing authority.

At block 266, the method 250 includes the step of lowering a driver-side window partially subsequent to the generation of indications associated with the approaching emergency response vehicle. In an embodiment, the lowering of the window is facilitated by the processor 102, which is communicatively coupled to the automatic window closer unit 118 of the vehicle 200. In another embodiment, the processor 102 may be configured to send an “open” signal to the automatic window closer unit 118 to facilitate opening of all the windows of the vehicle, thereby making the process more secure for the law enforcing authority. It is to be noted that the step 264 is performed when the processor 102 and the signal processing unit 108 detect that the approaching emergency response vehicle is a vehicle belonging to a law enforcing authority.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system comprising: one or more processors and one or more computer-readable non-transitory storage media coupled to one or more of the processors, the one or more computer-readable non-transitory storage media including instructions operable when executed by one or more of the processors to:
capture sound waves within a pre-defined periphery around a vehicle, via a sound capturing unit, wherein the sound capturing unit is disposed at a location either on an exterior of the vehicle or an interior of the vehicle for generating a first raw signal;
process, via a signal processing unit, the first raw signal to detect if the first raw signal includes a siren audio signature matching with one siren audio signature from a database of siren audio signatures pre-fed into the storage media, and correspondingly generate a second signal;
receive the second signal and generating a third signal based on whether the second signal includes the siren audio signature matching with one siren audio signature from the database of siren audio signatures; and
transmit the third signal to a plurality of indicator units configured within the interior of vehicle, wherein the plurality of indicator units is configured to generate indications on receiving the third signal for alerting a driver of the vehicle of an approaching emergency response vehicle.

2. The system according to claim 1, wherein the one or more processors are communicatively coupled to a vibration motor located in a driver seat or a steering wheel of the vehicle and configured for providing a nudge or a haptic feedback to the driver subsequent to the generation of indications associated with the approaching emergency response vehicle.

3. The system according to claim 1, wherein the one or more processors are communicatively coupled to an engine of the vehicle and configured to gradually detune and slow down the operation of the engine subsequent to the generation of indications associated with the approaching emergency response vehicle.

4. The system according to claim 1, wherein the one or more processors are communicatively coupled to a central door locking unit of the vehicle and configured to unlock the doors of the vehicle subsequent to the generation of indications associated with the approaching emergency response vehicle.

5. The system according to claim 1, wherein the one or more processors are communicatively coupled to an automatic window closer unit of the vehicle and configured to lower at least one window partially or completely subsequent to the generation of indications associated with the approaching emergency response vehicle.

6. The system according to claim 1, wherein the plurality of indicator units include at least one of an interior ambient light, an LED, a multi-information display of the vehicle, and an infotainment unit of the vehicle.

7. A method comprising:
capturing sound waves within a first pre-defined periphery around a vehicle, via a sound capturing unit for generating a first raw signal;
processing the first raw signal to detect if the first raw signal includes a siren audio signature matching with one siren audio signature from a database of siren audio signatures pre-fed into the storage media, and correspondingly generate a second signal;
receiving the second signal and generating a third signal based on whether the second signal includes the siren audio signature matching with one siren audio signature from the database of siren audio signatures; and
receiving the third signal and generating indications on receiving the third signal for alerting a driver of the vehicle of an approaching emergency response vehicle.

8. The method according to claim 8, further comprising the step of providing a nudge or a haptic feedback to the driver of the vehicle subsequent to the generation of indications associated with the approaching emergency response vehicle.

9. The method according to claim 8, further comprising the step of gradually detuning and slowing down the operation of an engine of the vehicle subsequent to the generation of indications associated with the approaching emergency response vehicle.

10. The method according to claim 8, further comprising the step of unlocking doors of the vehicle subsequent to the generation of indications associated with the approaching emergency response vehicle.

11. The method according to claim 8, further comprising the step of lowering at least one window of the vehicle partially or completely subsequent to the generation of indications associated with the approaching emergency response vehicle.

12. The method according to claim 8, wherein the indications are generated via a plurality of indicator units including at least one of an interior ambient light, an LED, a multi-information display of the vehicle, and an infotainment unit of the vehicle.
